(19) United States
(12) Patent Application Publication
(10) Pub. No.: US 2026/0022217 A1
(43) Pub. Date: Jan. 22, 2026

(54) COMPOSITE RESIN COMPOSITION AND MOLDED ARTICLE THEREOF

(71) Applicant: Panasonic Intellectual Property Management Co., Ltd., Osaka (JP)

(72) Inventors: AMI FUKU, Osaka (JP); KEI TOYOTA, Osaka (JP); TOSHIFUMI NAGINO, Osaka (JP); RYOUHEI SEKI, Osaka (JP)

(21) Appl. No.: 19/340,792

(22) Filed: Sep. 25, 2025

Related U.S. Application Data
(63) Continuation of application No. PCT/JP2024/012959, filed on Mar. 29, 2024.

(30) Foreign Application Priority Data
Apr. 13, 2023 (JP) 2023-065658

(51) Int. Cl. C08J 5/04

(52) U.S. Cl. CPC C08J 5/045; C08J 2397/02; C08J 2467/04; C08J 2491/06

(57) ABSTRACT

A composite resin composition is a composite resin composition including: a biodegradable resin; a biodegradable fiber dispersed in the resin; and a lubricant, in which the fiber is contained in a content of 30 mass % or more and 99 mass % or less, and the lubricant is contained in a content of 0.5 mass % or more and 10 mass % or less, with respect to 100 mass % of the composite resin composition.

### TECHNICAL FIELD

The present disclosure relates to a composite resin composition that is excellent in mechanical properties and durability and exhibits excellent biodegradability, and a molded article thereof.

### BACKGROUND ART

So-called “general-purpose plastics” such as polyethylene (PE), polypropylene (PP), polystyrene (PS), and polyvinyl chloride (PVC) are not only very inexpensive but also easy to mold, and have a weight as small as a fraction of that of metal or ceramics.

Therefore, general-purpose plastics are often used as materials of various daily commodities such as bags, various packaging, various containers, and sheets, and as materials for industrial components such as automobile components and electrical components, daily necessities, and miscellaneous goods.

Under such circumstances, the amount of plastic waste after use is increasing year by year, and plastic waste, which is a substance having a property of being hardly decomposed, accumulates in the natural environment and causes pollution problems such as destruction and pollution in the natural environment. In recent years, biodegradable plastics that are decomposed into water and carbon dioxide in the natural environment have been proposed as one of the measures to solve such various problems. It is expected that the use thereof will be expanded instead of general-purpose plastics using petroleum-based raw materials.

However, biodegradable plastics have disadvantages such as insufficient mechanical strength and durability as compared with general-purpose plastics. Therefore, biodegradable plastics do not have sufficient properties required for materials used for machine products such as automobiles and various industrial products including electric/electronic/information products, and the application range thereof is currently limited.

In addition, the biodegradation rate of the biodegradable plastics is greatly affected by the environment. In an environment with a small number of microorganisms, it takes significantly long time to completely decompose the biodegradable plastics, and the properties of biodegradability are not sufficiently utilized.

In order to solve these problems, a method of combining a biodegradable resin with a hydrolysis inhibitor to impart durability (see, PTL 1, etc.), and a product containing a microorganism having an ability to decompose a biodegradable resin to promote its decomposition rate (see, PTL 2, etc.) are disclosed.

### CITATION LIST

### Patent Literature

PTL 1: Unexamined Japanese Patent Publication No. 2006-291091
PTL 2: Unexamined Japanese Patent Publication No. 2013-209587

### SUMMARY OF THE INVENTION

In PTL 1, the decomposition rate in the natural environment may be reduced by the combined hydrolysis inhibitor. PTL 2, while improving the decomposition rate, does not mention a method for improving mechanical properties or suppressing decomposition.

An aspect of the present disclosure has been made to solve the above conventional problems, and an object of the present disclosure is to provide a composite resin composition that promotes biodegradation in the ocean or the soil while reducing the amount of petroleum-derived resins used.

A composite resin composition according to an aspect of the present disclosure is a composite resin composition including: a biodegradable resin; a biodegradable fiber dispersed in the resin; and a lubricant, in which the fiber is contained in a content of 30 mass % or more and 99 mass % or less, and the lubricant is contained in a content of 0.5 mass % or more and 10 mass % or less, with respect to 100 mass % of the composite resin composition.

A composite resin molded article according to an aspect of the present disclosure is a composite resin molded article obtained by molding the composite resin composition.

### BRIEF DESCRIPTION OF THE DRAWINGS

FIG. 1 is a schematic cross-sectional view illustrating the cross-sectional structure of a composite resin composition according to the first exemplary embodiment.

FIG. 2 is a schematic cross-sectional view illustrating the cross-sectional structure of a composite resin composition according to the first exemplary embodiment after immersion in water at 60° C. for 24 hours.

FIG. 3 is a schematic cross-sectional view illustrating the cross-sectional structure of a composite resin composition containing a fiber having a defibrated site according to the first exemplary embodiment.

FIG. 4 is a flowchart of a method for producing a composite resin composition according to the first exemplary embodiment; and a method for producing a composite resin molded article using the composite resin composition.

FIG. 5 is a diagram showing the configurations and measurement results of composite resin molded articles in an example and comparative examples in the exemplary embodiment.

### DESCRIPTION OF EMBODIMENT

A composite resin composition according to a first aspect is a composite resin composition including: a biodegradable resin; a biodegradable fiber dispersed in the resin; and a lubricant, in which the fiber is contained in a content of 30 mass % or more and 99 mass % or less, and the lubricant is contained in a content of 0.5 mass % or more and 10 mass % or less, with respect to 100 mass % of the composite resin composition.

A composite resin composition according to a second aspect is the composite resin composition in the first aspect, in which the fiber may include a fiber having a defibrated site formed at an end in a fiber length direction.

A composite resin composition according to a third aspect is the composite resin composition in the first or second aspect, in which the biodegradable fiber may have a water content of 5% or more in accordance with a method specified in JIS L0105:2020.

A composite resin composition according to a fourth aspect is the composite resin composition in any one of the first to third aspects, in which the resin may contain at least one of polyhydroxyalkanoic acid, polybutylene succinate, polylactic acid, polybutylene adipate-co-terephthalate, polycaprolactone, polyamide, modified starch, and derivatives thereof.

A composite resin composition according to a fifth aspect is the composite resin composition in any one of the first to fourth aspects, in which the resin may be a thermoplastic biodegradable resin having a flexural modulus of 100 MPa or more.

A composite resin composition according to a sixth aspect is the composite resin composition in any one of the first to fifth aspects, in which the lubricant may contain a long-chain aliphatic carboxylic acid, a long-chain aliphatic primary alcohol, or a long-chain aliphatic ester, each having 15 or more carbon atoms, in an amount of 50 mol % or more.

A composite resin composition according to a seventh aspect is the composite resin composition in any one of the first to sixth aspects, in which the lubricant may have a melting point of 25° C. or more and 70° C. or less.

A composite resin composition according to an eighth aspect is the composite resin composition in any one of the first to seventh aspects, in which the fiber may be a cellulose.

A composite resin molded article according to a ninth aspect is obtained by molding the composite resin composition in any one of the first to eighth aspects.

The composite resin molded article according to a tenth aspect is the composite resin molded article in the ninth aspect, in which the composite resin molded article may have a contact angle with water of 80° or more at 25° C. or less.

The composite resin molded article according to an eleventh aspect is the composite resin molded article in the ninth or tenth aspect, in which the composite resin molded article may have a contact angle with water of less than 80° after the composite resin molded article is immersed in water at 60° C. for 24 hours.

The composite resin composition according to an aspect of the present disclosure can realize a composite resin molded article not only having a high elastic modulus, but also having improved durability under a normal temperature environment and high biodegradability under a high temperature environment such as an industrial compost, as compared with the resin alone.

Hereinafter, the composite resin composition according to the exemplary embodiment and the method for producing the molded article thereof will be described with reference to the accompanying drawings. In the following description, the same components are denoted by the same reference marks, and the description thereof is appropriately omitted.

### First Exemplary Embodiment

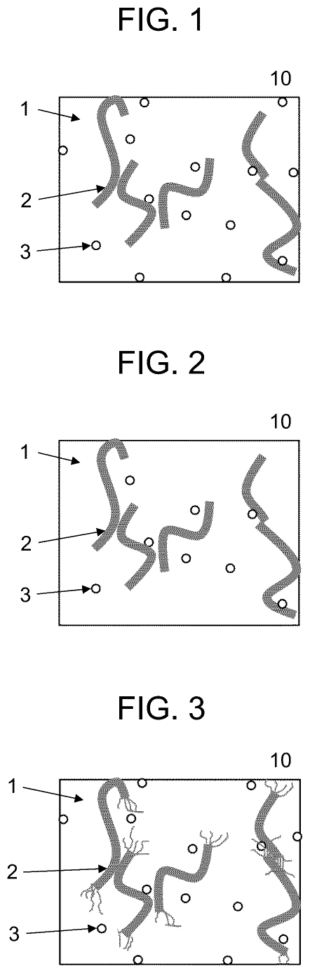

FIG. 1 is a schematic cross-sectional view illustrating the cross-sectional structure of composite resin composition 10 according to the first exemplary embodiment.

Composite resin composition 10 according to the first exemplary embodiment is formed of a melt-kneaded product containing resin 1, fiber 2, lubricant 3, and as necessary, an additive. In composite resin composition 10, as illustrated in the schematic cross-sectional view of FIG. 1, fiber 2 and lubricant 3 are dispersed in resin 1. Under a normal temperature environment of 25° C. or lower, composite resin composition 10 has a hydrophobized surface by the effect of lubricant 3 contained in composite resin composition 10, thereby suppressing: water absorption by fiber 2; and decomposition by microorganisms.

FIG. 2 is a schematic cross-sectional view illustrating the cross-sectional structure of composite resin composition 10 according to the first exemplary embodiment after immersion in water at 60° C. for 24 hours. As shown in FIG. 2, under a high temperature environment of 60° C. or higher such as an industrial compost, a part of lubricant 3 at the surface of composite resin composition 10 is eluted and desorbed, so that composite resin composition 10 has a hydrophilized surface, thereby promoting: water absorption by fiber 2; and decomposition by microorganisms.

FIG. 3 is a schematic cross-sectional view illustrating the cross-sectional structure of composite resin composition 10 containing fiber 2 having a defibrated site according to the first exemplary embodiment. As illustrated in FIG. 3, when the defibrated site is included at an end of fiber 2, the specific surface area of the defibrated site is increased and the number of contact points between fibers 2 is increased. This makes it possible to absorb water into the inside of composite resin composition 10 via the contact points between fibers 2 under a high temperature environment.

At least one fiber 2 is exposed on the surface of the composite resin molded article. Composite resin composition 10 can realize a composite resin molded article: having at least one fiber 2 exposed on the surface of the composite resin molded article; and not only having a high elastic modulus, but also having durability under a normal temperature environment and high water absorption and excellent biodegradability under a high temperature environment such as an industrial compost.

Hereinafter, each member constituting composite resin composition 10 will be described.

### <Resin>

In the first exemplary embodiment, resin 1 is preferably a biodegradable plastic containing any of a polyhydroxyalkanoic acid, a polyhydroxyalkanoate, a polyalkylene dicarboxylate, and a modified starch. To ensure good moldability and mechanical properties, a thermoplastic resin having a flexural modulus of 100 MPa or more is preferable, and the above resin may be used alone or in combination of two or more thereof. Resin 1 is not limited to the above materials as long as it has biodegradability.

In the exemplary embodiment, the term “biodegradable plastic” refers to “resin that has a function similar to that of a conventional petroleum-derived resin at the time of use, and is finally decomposed into water and carbon dioxide by microorganisms in the soil or the ocean in nature after use”. Specific examples thereof include polyhydroxyalkanoic acids such as polyhydroxybutyrate and polyhydroxyvalerate; polyhydroxy acids such as polylactic acid, polyglycolic acid, and polycaprolactone; polyester-based resins including polyalkylene dicarboxylates such as polybutylene adipate-terephthalate, polyethylene succinate, and polybutylene succinate; polyamides; modified starches; and derivatives thereof. Examples of the polyester-based resin include, in addition to a homopolymer of a polyester-based monomer, a copolymer of polyester-based monomers such as poly(3-hydroxybutyrate-co-3-hydroxyvalerate), and a copolymer of a polyester-based monomer and another copolymerizable monomer. These polyester-based resins may be used alone or in combination of two or more thereof.

### <Fiber>

Next, fiber 2 will be described. The main first purpose of adding fiber 2 to composite resin composition 10 according to the first exemplary embodiment is to promote the decomposition of the molded article when the molded article made of composite resin composition 10 is discarded after use. That is, under a high temperature environment of 60° C. or higher such as an industrial compost, water is absorbed to the inside of the molded article due to fiber 2. Thereby, the decomposition of the molded article is promoted. For this purpose, fiber 2 preferably has high biodegradability and water absorbency, and the water content of fiber 2 is preferably 5% or more in accordance with the method specified in JIS L0105:2020. Specifically, pulp, cellulose, cellulose nanofibers, lignocellulose, lignocellulose nanofibers, cotton, silk, and hemp are preferable.

The second purpose of adding fiber 2 is to improve mechanical properties and to improve dimensional stability by decreasing the linear expansion coefficient. For this purpose, fiber 2 preferably has a higher elastic modulus than resin 1. Specific examples thereof include pulp, cellulose, cellulose nanofibers, lignocellulose, lignocellulose nanofibers, cotton, silk, wool, and hemp. Further, among them, celluloses are particularly preferable from the viewpoint of availability, high elastic modulus, and low linear expansion coefficient. Note that fiber 2 is not limited to the above materials as long as it can improve mechanical properties and has biodegradability and water absorbency.

The content of fiber 2 is preferably 30 mass % or more and 99 mass % or less with respect to 100 mass % of the composite resin composition. When the content of fiber 2 is less than 30 mass %, fibers 2 are less likely to have a contact point with each other inside the composite resin composition, and thus sufficient water absorbency is not attained. On the other hand, when the content of fiber 2 is more than 99 mass %, the proportion of resin 1 decreases, so that the effect of bonding fibers 2 to each other is lost and moldability is thus deteriorated. From the viewpoint of water absorbency and moldability, the content of fiber 2 is more preferably 40 mass % or more and 70 mass % or less.

The form of fiber 2 in the composite resin molded article will be described. When the bonding interface between fiber 2 and resin 1 is large, the area of resin 1 that can come into contact with microorganisms during water absorption and expansion of fiber 2 increases, and therefore the specific surface area of fiber 2 is preferably large. On the other hand, in order to improve the water absorbency of the composite resin molded article, fiber 2 is preferably exposed on the surface of the composite resin molded article. Since fiber 2 is exposed on the surface of the composite resin molded article, water is absorbed from the exposed portion of fiber 2, and water is absorbed into the inside of the composite resin molded article by the capillary phenomenon of fiber 2. Fiber 2 exposed on the surface of the composite resin molded article has higher water absorbency as the specific surface area is smaller. This is because when the specific surface area of fiber 2 exposed on the surface is large, water repellency is enhanced because of the effect of fine irregularities. Further, as illustrated in FIG. 3, by having a defibrated site at an end of fiber 2, the specific surface area of the defibrated site increases, and the number of contact points between fibers 2 increases. Thus, when the composite resin molded article has a hydrophilized surface under a high temperature environment of 60° C. or higher such as an industrial compost, the water absorption percentage can be increased via the contact points between fibers 2.

The central portion of fiber 2, which has a small specific surface area and is not defibrated, is less entangled with resin 1 and is easily exposed to the surface of the composite resin molded article depending on the molding conditions. On the other hand, the tip portion of defibrated fiber 2 is highly entangled with resin 1, and enters the inside together with resin 1. This makes it possible to obtain a composite resin molded article in which the central portion of fiber 2 not including both ends is exposed to the surface.

The tip defibrated site is preferably 5% or more and 50% or less of the fiber length of entire fiber 2. When the length of the defibrated site is less than 5% of the total fiber length, the elastic modulus is not improved because the specific surface area is small, and when the length of the defibrated site is more than 50% of the fiber length, the defibrated site having a high aspect ratio is exposed on the surface of the composite resin molded article, so that water absorbency is deteriorated.

Next, the state of existence of fiber 2 in the composite resin molded article will be described. The composite resin molded article includes: a surface layer; and an inner layer located on the inner side of the surface layer. By adjusting the molding conditions and increasing the shrinkage rate when the composite resin composition is molded, fiber 2 can be segregated in the vicinity of the surface of the composite resin molded article. As a result, fiber 2 is present more in the surface layer than in the inner layer of the composite resin molded article. In addition, seen as a molded article, when fiber 2 is present more in the surface layer of the composite resin molded article, the elastic modulus of the outer side thereof becomes higher, so that the rigidity of the entire molded article increases. Accordingly, the structure in which fiber 2 is segregated in the vicinity of the surface of the molded article also leads to improved rigidity. The segregation of fiber 2 in the vicinity of the surface can be evaluated by SEM observation of the cross section of the composite resin molded article, or the like.

Next, the properties of fiber 2 will be described. The types of resin 1 and fiber 2 are as described above. However, when fiber 2 is too soft, that is, has a small elastic modulus, with respect to resin 1, the composite resin molded article has a small elastic modulus as a whole, resulting in decreased strength. On the other hand, when fiber 2 is too hard, that is, has a large elastic modulus with respect to resin 1, shock waves generated at the time of impact are not propagated, and the impact is absorbed at the interface between resin 1 and fiber 2. For this reason, cracking and crazing are likely to occur in the vicinity of the interface, resulting in reduced impact strength. Therefore, in the relationship of elastic modulus between resin 1 and fiber 2, it is preferable that the elastic modulus of fiber 2 is higher, and the difference thereof is as small as possible. The optimum relationship is calculated from simulation results, and the difference in elastic modulus between resin 1 and fiber 2 is preferably within 20 GPa.

Further, such fiber 2 may be surface-treated for the purpose of improving adhesion to resin 1 or dispersibility in the composite resin composition, or the like. However, when the water absorbency of fiber 2 is impaired by surface treatment, it is preferable not to perform surface treatment in advance.

### <Lubricant>

Next, lubricant 3 will be described. In the first exemplary embodiment, under a normal temperature environment, lubricant 3 is used for the purpose of hydrophobizing the surface of the composite resin molded article to inhibit: water absorption and expansion by fiber 2; and adsorption of decomposing microorganisms and/or enzymes, thereby suppressing decomposition. On the other hand, under a high temperature environment such as an industrial compost, lubricant 3 is used for the purpose that lubricant 3 is eluted, thereby hydrophilizing the surface of the composite resin molded article, to promote: water absorption and expansion by fiber 2; and adsorption of decomposing microorganisms and/or enzymes. Therefore, lubricant 3 preferably has a melting point of 25° C. or more and 70° C. or less.

The content of lubricant 3 is preferably 0.5 mass % or more and 10 mass % or less with respect to 100 mass % of the composite resin composition. When the content of lubricant 3 is less than 0.5 mass %, it is difficult to obtain the effect of hydrophobizing the surface of the composite resin molded article under a normal temperature environment. On the other hand, when the content of lubricant 3 is more than 10 mass %, the mechanical characteristics of the composite resin molded article may be deteriorated. From the viewpoint of hydrophobicity and mechanical properties, the content of lubricant 3 is more preferably 1 mass % or more and 5 mass % or less.

The composite resin molded article containing lubricant 3 preferably has a contact angle with water of 80° or more at 25° C. or less. Further, the composite resin molded article containing lubricant 3 preferably has a contact angle with water of less than 80° after being immersed in water at 60° C. for 24 hours. In order to control the hydrophilicity of the composite resin molded article depending on temperature, lubricant 3 preferably contains a long-chain aliphatic carboxylic acid, a long-chain aliphatic primary alcohol, or a long-chain aliphatic ester, each having 15 or more carbon atoms, in an amount of 50 mol % or more. In a case where the number of carbon atoms is less than 15, when lubricant 3 is combined, the hydrophobicity is reduced under a normal temperature environment. When lubricant 3 contains a long-chain aliphatic carboxylic acid, a long-chain aliphatic primary alcohol, or a long-chain aliphatic ester, each having 15 or more carbon atoms, in an amount of less than 50 mol %, the intended functions, such as controlling melting point and hydrophilicity or hydrophobicity, are not exhibited.

### <Additive>

Next, the additive will be described. The additive may be used as necessary for the purpose of improving affinity between resin 1 and fiber 2, or the like.

### <Method for Producing Composite Resin Composition>

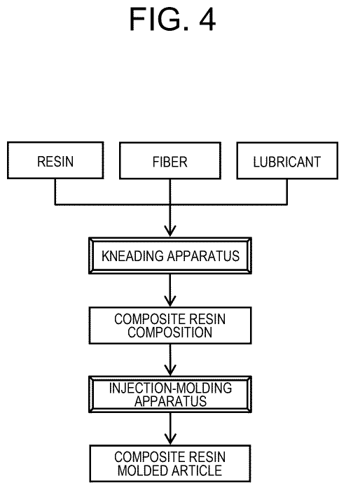

Next, the method for producing the composite resin composition will be described. FIG. 4 is a flowchart showing an example of a method for producing a composite resin composition according to the first exemplary embodiment; and a method for producing a composite resin molded article using the composite resin composition.

(1) Resin 1, fiber 2, lubricant 3, and an additive are charged into a melt-kneading apparatus, and are melt-kneaded in the apparatus. As a result, resin 1 is melted, and fiber 2, lubricant 3, and the additive are dispersed in molten resin 1. At the same time, the shearing action of the apparatus promotes defibration of aggregates of fiber 2, and fiber 2 can be finely dispersed in resin 1.

Conventionally, when fibers or the like are combined with a resin, fibers that have been defibrated in advance by a pretreatment such as wet dispersion have been used. However, in the defibration by wet dispersion, the fibers are easier to be defibrated than to be defibrated in the molten resin, and thus it is difficult to defibrate only the end thereof, and the entire fiber is defibrated. Further, there is a problem that the number of steps increases and productivity deteriorates by combining the pretreatment.

On the other hand, in the production process of a composite resin composition in the exemplary embodiment, a melt-kneading treatment (all-dry method) is performed together with resin 1, lubricant 3, an additive, and the like, without performing a pretreatment by wet dispersion for the purpose of defibrating fiber 2. In this method, since the wet dispersion treatment of the fiber is not performed, swelling of fiber 2 in the production process is suppressed, and the hygroscopic expansion coefficient of fiber 2 in resin 1 of the composite resin composition can be improved. In addition, when fiber 2 is dried in advance, or during kneading, to adjust the water content to 5% or less, the expansion coefficient at water absorption can be further improved in resin 1.

In order to prepare fiber 2 of the exemplary embodiment by the all-dry method, it is preferable to apply high shear stress during kneading. Specific examples of the kneading method include a uniaxial kneader, a biaxial kneader, a roll kneader, a Banbury mixer, and a combination thereof. From the viewpoint of easy application of high shear and high mass productivity, a continuous biaxial kneader and a continuous roll kneader are particularly preferable. A kneading method other than the above may be used as long as high shear stress can be applied.

The composite resin composition can be obtained by the above kneading step.

### <Method for Producing Composite Resin Molded Article>

(2) The composite resin composition extruded from the melt-kneading apparatus is prepared in a pellet form through a cutting process such as a pelletizer. The pelletizing method includes a method of performing pelletization immediately after melting the resin, such as an air hot cut method, an underwater hot cut method, and a strand cut method. Alternatively, there is also a pulverization method in which a molded article or a sheet is once molded and then pulverized and cut.

(3) By injection-molding the pellets, an injection-molded article as a composite resin molded article can be prepared. Since fiber 2 in the pellet is mixed with resin 1 as described above, an injection-molded article excellent in elastic modulus, impact resistance, and appearance can be obtained.

Hereinafter, examples and comparative examples in experiments performed by the inventors will be described.

### Example 1

In Example 1, a cellulose-combined polylactic acid resin molded article was produced by the following production method.

Softwood pulp (product name: NBKP Celgar, manufactured by Mitsubishi Paper Mills Limited) was used as a starting material for the fiber. As the resin, a polylactic acid (manufactured by UNITIKA LTD., trade name: TE-2000) was used. A rice wax having a melting point of 70° C. (trade name: ECOSOLE-1500, from NIPPON SEIRO CO., LTD.) was used as the lubricant. The softwood pulp, which had been dried in advance and adjusted to have a water content of 5% or less, the polylactic acid, and the rice wax were weighed at 55:44:1 in terms of weight ratio, and dry-blended.

Then, the dry blend was melt-kneaded with a biaxial kneader (KRC kneader, manufactured by Kurimoto, Ltd.). The screw was of a medium shear type. The melt-kneading conditions included a resin temperature of 200° C. and a rotation speed of 50 min⁻¹. The composite resin composition discharged from the biaxial kneader was hot-cut to prepare pellets of the cellulose-combined polylactic acid resin.

A test piece of the cellulose-combined polylactic acid resin molded article was prepared using the prepared pellets of the cellulose-combined polylactic acid with an injection-molding machine (180AD, manufactured by The Japan Steel Works, Ltd.). The production conditions of the test piece included a resin temperature of 200° C., a mold temperature of 30° C., an injection speed of 100 mm/s, and a holding pressure of 100 Pa. The shape of the test piece was changed according to the evaluation items described below, and a dumbbell having a size of No. 1 was prepared for measuring the elastic modulus. The obtained test piece of the cellulose-combined polylactic acid resin molded article was evaluated by the following methods.

### (Evaluation of Water Absorbency of Fiber)

The water absorbency of the fiber was evaluated by measuring the water content of the fiber in accordance with the method specified in JIS L0105:2020. Specifically, the weight of the fiber dried at 80° C. for 24 hours was measured and taken as a reference weight. Thereafter, the weight of the fiber maintained at a temperature of 20° C. and a humidity of 65% for 24 hours was measured. The water content was calculated such that the weight increase from the reference weight was regarded as water. A water content of less than 5% was rated as C; and 5% or more was rated as A. The softwood pulp had a water content of 6.5%, and was rated as A (the end defibration property of the fiber).

The obtained cellulose-combined polylactic acid resin composition was immersed in chloroform to dissolve polylactic acid, and the remaining cellulose fibers were observed with a SEM (scanning electron microscope) to observe the shape of the fiber. The end of the fiber was defibrated.

### (Elastic Modulus of Composite Resin Molded Article)

A bending test was performed using the obtained No. 1 dumbbell-shaped test piece. Here, as the method for evaluating the elastic modulus, a numerical value of 6.5 GPa or more was rated as A; and less than 6.5 GPa was rated as C.

The test piece had an elastic modulus of 6.9 GPa, and was rated as A.

### (Evaluation of Hydrophilicity of Composite Resin Molded Article)

The contact angle with water was measured using the obtained No. 1 dumbbell-shaped test piece. For evaluating hydrophilicity under a normal temperature environment, 3 μL of distilled water was dropped onto the test piece at room temperature of 23° C., and after 1 second, the contact angle was measured. As the method for evaluating hydrophilicity under a normal temperature environment, a contact angle with water of 80° or more was rated as A; and less than 80° was rated as C.

The test piece had a contact angle with water of 88.4°, and was rated as A.

For evaluating hydrophilicity under a high temperature environment, the test piece was immersed in distilled water at 60° C. for 24 hours, then water on the surface was wiped off, 3 μL of distilled water was dropped onto the test piece at room temperature of 23° C., and after 1 second, the contact angle was measured. As the method for evaluating hydrophilicity under a high temperature environment, a contact angle with water of less than 80° was rated as A; and 80° or more was rated as C.

The test piece had a contact angle with water of 72.3°, and was rated as A.

### (Evaluation of Biodegradability of Composite Resin Molded Article)

A biodegradation test was performed using a bar-shaped test piece formed of the obtained composite resin molded article by a method in accordance with JIS K 6953-1:2011. Specifically, into a plastic container, 60 mL of a compost planting source (YK-12, from Yawata Corporation) was placed, a bar-shaped test piece having a height of 20 mm, a width of 10 mm, and a thickness of 4 mm, the weight of which was measured in advance, was embedded in the planting source, and held at a temperature of 58° C. and a water content of 50%, and then the weight loss after 1 month was evaluated. As the method for evaluating the biodegradation percentage, a numerical value of 8% or more was rated as A; 5% or more and less than 8% was rated as B; and less than 5% was rated as C.

The test piece had a biodegradation percentage of 9.1%, and was rated as A.

### Comparative Example 1

In Comparative Example 1, a polylactic acid resin molded article was prepared in the same process conditions as in Example 1 except that a polylactic acid was used as a raw material without combining a fiber and a lubricant. The evaluation was performed in the same manner as in Example 1.

### Comparative Example 2

In Comparative Example 2, pellets of the cellulose-combined polylactic acid resin and a composite resin molded article were prepared in the same material conditions and process conditions as in Example 1 except that no lubricant was combined. The evaluation was performed in the same manner as in Example 1.

### Comparative Example 3

In Comparative Example 3, pellets of the cellulose-combined polylactic acid resin and a composite resin molded article were prepared in the same material conditions and process conditions as in Example 1 except that a carnauba wax having a melting point of 82° C. was used as the lubricant instead of the rice wax. The evaluation was performed in the same manner as in Example 1.

### Comparative Example 4

In Comparative Example 4, pellets of a PET fiber-combined polylactic acid resin and a composite resin molded article were prepared in the same material conditions and process conditions as in Example 1 except that a PET fiber was used as the fiber instead of the softwood pulp. The evaluation was performed in the same manner as in Example 1.

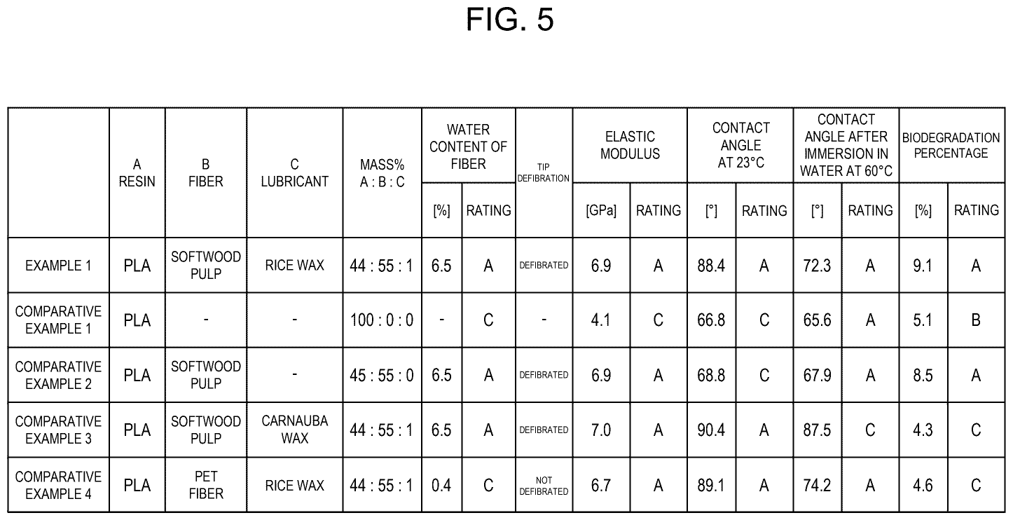

FIG. 5 shows the configurations and measurement results of the composite resin molded articles in Example 1 and Comparative Examples 1 to 4.

As is apparent from FIG. 5, in Example 1, in which cellulose and rice wax were combined with polylactic acid, the elastic modulus was as high as 6.9 GPa, and the combined lubricant improved the hydrophobicity of the surface of the molded article under a normal temperature environment, as compared with the cellulose-combined polylactic acid resin molded article in Comparative Example 2, in which no lubricant was contained. On the other hand, under a high temperature environment, the molded article had a hydrophilized surface, and exhibited water absorbency due to cellulose, thereby also having an improved biodegradation percentage, as compared with the polylactic acid resin molded article in Comparative Example 1. It was confirmed that, when a fiber having high water absorbency is combined, and a lubricant that hydrophobizes the surface of the molded article under a normal temperature environment and hydrophilizes the surface of the molded article under a high temperature environment is combined, a composite resin having a high elastic modulus, high durability, and high biodegradability can be obtained.

In Comparative Example 3, in which carnauba wax was combined as the lubricant, the lubricant has a melting point of higher than 70° C. Therefore, as compared with Example 1, the contact angle with water after immersion in water at 60° C. was high, and the biodegradation percentage was reduced to 4.3%, and was rated as C.

In Comparative Example 4, in which a PET fiber was combined as the fiber, the fiber had a small water content, and therefore the molded article did not absorb water even after hydrophilized under a high temperature environment. Thus, as compared with Example 1, the biodegradation percentage was reduced to 4.6%, and was rated as C.

From the above evaluation, it was confirmed that, when a fiber having high water absorbency is combined, and a lubricant that hydrophobizes the surface of the molded article under a normal temperature environment and hydrophilizes the surface of the molded article under a high temperature environment is combined, a composite resin having a high elastic modulus, high durability, and high biodegradability can be obtained.

Note that the present disclosure includes an appropriate combination of any exemplary embodiment and/or example among the various exemplary embodiments and/or examples described above, and effects of the respective exemplary embodiments and/or examples can be achieved.

### INDUSTRIAL APPLICABILITY

With the composite resin composition according to the present disclosure, it is possible to provide a molded article having mechanical strength and biodegradability superior to those of conventional biodegradable plastics. Since the properties of the resin can be improved by the present invention, the composite resin composition can be used as an alternative to petroleum-derived general-purpose plastics. Therefore, the environmental load of various industrial products or daily commodities made of petroleum-derived general-purpose plastics can be significantly reduced. Further, the composite resin composition can be used for packaging materials, daily necessities, housings for household electric appliances, building materials, and the like.

### REFERENCE MARKS IN THE DRAWINGS

1 resin
2 fiber
3 lubricant
10 composite resin composition

1. A composite resin composition comprising:
a biodegradable resin;
a biodegradable fiber dispersed in the resin; and
a lubricant,
wherein the fiber is contained in a content of 30 mass % or more and 99 mass % or less, and the lubricant is contained in a content of 0.5 mass % or more and 10 mass % or less, with respect to 100 mass % of the composite resin composition.

2. The composite resin composition according to claim 1, wherein the fiber includes a fiber having a defibrated site formed at an end in a fiber length direction.

3. The composite resin composition according to claim 1, wherein the fiber has a water content of 5% or more in accordance with a method specified in JIS L0105:2020.

4. The composite resin composition according to claim 1, wherein the resin contains at least one of polyhydroxyalkanoic acid, polybutylene succinate, polylactic acid, polybutylene adipate-co-terephthalate, polycaprolactone, polyamide, modified starch, and derivatives thereof.

5. The composite resin composition according to claim 1, wherein the resin is a thermoplastic biodegradable resin having a flexural modulus of 100 MPa or more.

6. The composite resin composition according to claim 1, wherein the lubricant contains a long-chain aliphatic carboxylic acid, a long-chain aliphatic primary alcohol, or a long-chain aliphatic ester, each having 15 or more carbon atoms, in an amount of 50 mol % or more.

7. The composite resin composition according to claim 1, wherein the lubricant has a melting point of 25° C. or more and 70° C. or less.

8. The composite resin composition according to claim 1, wherein the fiber is a cellulose.

9. A composite resin molded article obtained by molding the composite resin composition according to claim 1.

10. The composite resin molded article according to claim 9, wherein the composite resin molded article has a contact angle with water of 80° or more at 25° C. or less.

11. The composite resin molded article according to claim 9, wherein the composite resin molded article has a contact angle with water of less than 80° after the composite resin molded article is immersed in water at 60° C. for 24 hours.
